(19) United States
(12) Patent Application Publication
(10) Pub. No.: US 2011/0165040 A1
(43) Pub. Date: Jul. 7, 2011

(54) DEVICE FOR REMEDIATING EMISSIONS AND METHOD OF MANUFACTURE

(75) Inventors: Yinyan Huang, Northville, MI (US); Christine Kay Lambert, Dearborn, MI (US)

(73) Assignee: FORD GLOBAL TECHNOLOGIES, LLC, Dearborn, MI (US)

(21) Appl. No.: 12/938,649

(22) Filed: Nov. 3, 2010

(51) Int. Cl. B01J 8/00; B29C 47/00; B05D 5/00; B29C 47/78

(52) U.S. Cl. 422/616; 264/49; 427/256

(57) ABSTRACT

In at least one embodiment, a combined selective catalytic reduction catalyst and particulate filter (SCRF) includes a particulate filter having walls defining an intake channel including a downstream end cap and an outlet channel including an upstream end cap and an open end through which emissions pass. The walls define a plurality of pores. The walls include a plurality of zeolite-base metal particles and a binder. A washcoat is situated adjacent to less than 50% of the length of the outlet channel. The washcoat is capable of receiving noble metal particles.

### BACKGROUND

1. Field of the Invention

One aspect of the present invention relates to a device for remediating emissions and its method of manufacture.

2. Background Art

Emissions of regulatory concern include oxides of nitrogen. The oxides of nitrogen include, but are not limited to, nitric oxide, NO, and nitrogen dioxide, NO₂. These compounds are frequently referred to as NOx as prescribed by the United States Environmental Protection Agency.

Remediating systems have been proposed to remediate NOx in the emissions from diesel engines but are generally relatively expensive.

### SUMMARY

In at least one embodiment, a combined selective catalytic reduction catalyst and particulate filter (SCRF) includes a particulate filter having walls. The walls define an intake channel including a downstream end cap and an outlet channel including an upstream end cap and an open end through which emissions pass. The walls also define a plurality of pores. The walls include a plurality of zeolite-base metal particles. A washcoat is situated adjacent to less than 50% of the length of the outlet channel. The washcoat is capable of receiving noble metal particles.

In an alternative embodiment, a particulate filter has walls comprising a structural subunit and NH₃-oxidizing composition particle. The filter defines an intake channel including a downstream end cap and an outlet channel including an upstream end cap and an open end. The walls have a porosity ranging from 40 vol. % to 85 vol. %. A washcoat is situated adjacent to less than 50% of the length of the outlet channel. The washcoat is capable of receiving noble metal particles.

In yet another embodiment, a method of manufacture of a combined selective catalytic reduction catalyst and particulate filter (SCRF) includes ion-exchanging base metal ions into a plurality of zeolites to form a plurality of zeolite-base metal particles. The zeolite-base metal particles, a binder, and a pore-forming composition are mixed to form an extrudable mixture. The extrudable mixture is extruded to form a particulate filter having walls defining an intake channel including a downstream end cap and an outlet channel including an upstream end cap and an open end. The pore-former is incinerated to form a particulate filter having 40 vol. % to 85 vol. % pores. A coating is applied adjacent to less than 50% of the length of the outlet channel. The coating layer is heated to dry the layer. Noble metal is applied to the layer. The noble metal is heated to dryness to complete the SCRF.

### BRIEF DESCRIPTION OF THE DRAWINGS

FIG. 1 schematically illustrates an emissions remediation device according to certain embodiments;

FIG. 2 schematically illustrates a fragmentary cross-sectional view of a combined selective catalytic (SCR) catalyst and particulate filter SCRF along axis 303 of FIG. 1;

FIG. 3 schematically illustrates a cross-sectional view of a SCRF along axis 3-3 of FIG. 2;

FIG. 4 schematically illustrates a cross-sectional view of a SCRF along axis 4-4 of FIG. 2; and

FIG. 5 diagrammatically illustrates a method of manufacturing a SCRF according to at least one embodiment.

### DETAILED DESCRIPTION

Reference will now be made in detail to compositions, embodiments, and methods of the present invention known to the inventors. However, it should be understood that disclosed embodiments are merely exemplary of the present invention which may be embodied in various and alternative forms. Therefore, specific details disclosed herein are not to be interpreted as limiting, rather merely as representative bases for teaching one skilled in the art to variously employ the present invention.

Except where expressly indicated, all numerical quantities in this description indicating amounts of material or conditions of reaction and/or use are to be understood as modified by the word “about” in describing the broadest scope of the present invention. Practice within the numerical limits started should be desired and independently embodied.

The description of a group or class of materials as suitable for a given purpose in connection with the present invention implies that mixtures of any two or more of the members of the group or class are suitable. Description of constituents in chemical terms refers to the constituents at the time of addition to any combination specified in the description, and does not necessarily preclude chemical interactions among constituents of the mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

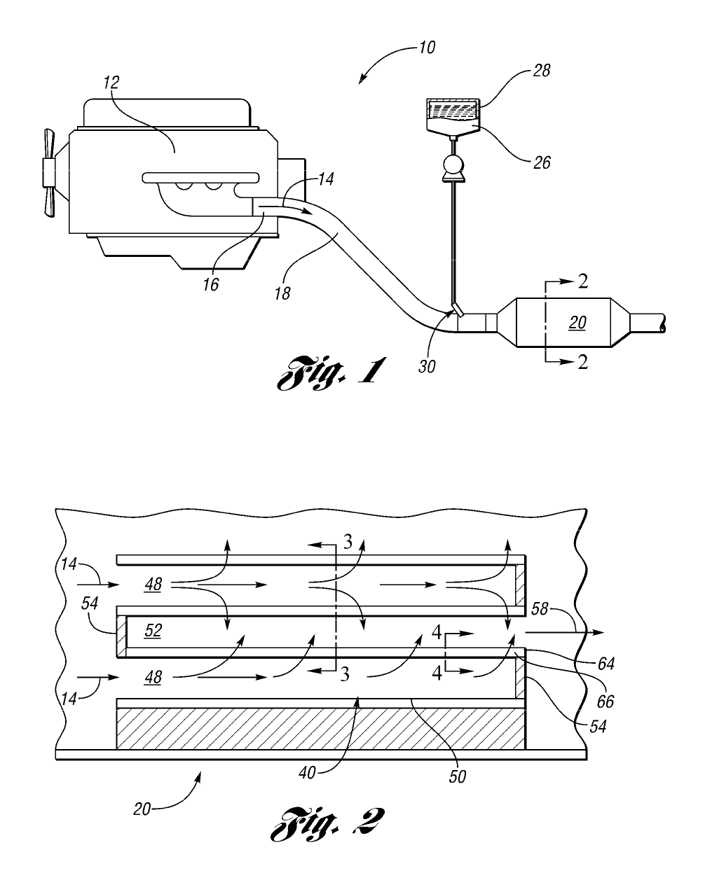

Referring now to FIG. 1, an exemplary remediation device is schematically illustrated. Remediation device 10 receives an exhaust 14 from an engine 12. Exhaust 14 enters the remediation device 10 at an intake 16 adjacent to engine 12. Exhaust 14 travels in an exhaust conduit 18, for example, a pipe, having a longitudinal axis. A portion of conduit 18 connects intake 16 with a combined selective catalytic reduction (SCR) catalyst and particulate filter (SCRF) 20. In the illustrated embodiment, a reductant 26, such as a reducing agent like urea, is stored in a storage vessel 28 and delivered to a reductant delivery system 30 by a conduit 32. Delivery system 30 is coupled to a portion of conduit 18 through an aperture upstream of SCRF 20.

The SCRF 20 is capable of improved control of CO, hydrocarbon and NH₃, preventing inadvertent slip of these gases from remediation device 10 during a variety of transient engine operation modes.

SCRF 20 is an integrated system allowing lower manufacturing costs and reduced use of expensive materials with the smaller volume of remediation device needed to achieve equivalent remediation control when compared with prior remediation systems.

SCRF 20 may be formed by a direct extrusion process where a base metal-zeolite selective catalytic reduction (SCR) catalyst composition is mixed with a binder, a pore-forming composition, and a support material prior to extrusion into a monolith. In at least one embodiment, SCRF 20 is capable of reducing the back pressure due to having a greater pore volume than previous remediation systems and having less washcoat clogging pores.

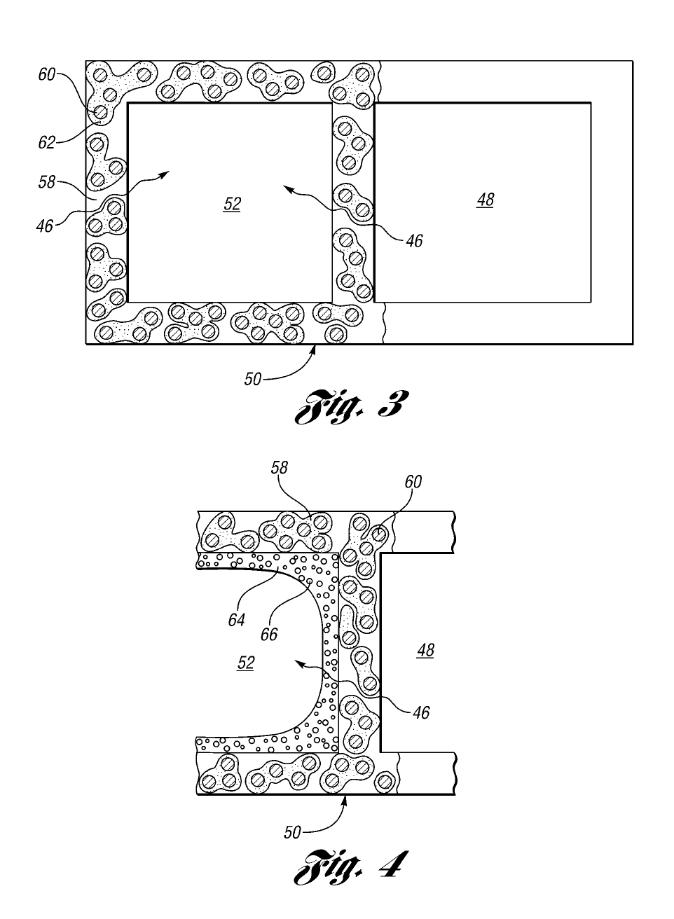

FIG. 2 illustrates a fragmentary cross-sectional view of SCRF 20 along axis 2-2 of FIG. 1. Substrate 40 is a particulate filter substrate, such as a diesel particulate filter. Substrate 40, when extruded, forms elongated channels 48 and 52. Alternating channels are plugged at alternating ends with plugs 54 forcing gas emission 46 to migrate through wall 50 from an inlet channel, such as channel 48, that receives gas to an outlet channel, such as channel 52, from which the gas exits as a remediated gas 58.

The walls 50 of substrate 40, in general, must have sufficient porosity to allow flow of emission 46 (FIG. 3) from inlet channel 48 to outlet channel 52 while removing particulate matter from the emission 46. Useful fabrication techniques for forming substrate 40 are disclosed in U.S. Pat. No. 5,069,697. The entire disclosure of which is hereby incorporated by reference. Substrate 40, in certain embodiments, may be a honeycombed monolith formed from a composition including a refractive material.

As schematically illustrated in FIG. 3, substrate 40, in at least one embodiment, may comprise a mixture of a plurality of zeolite and NO-oxidizing composition particles, such as zeolite-base metal particles 60, and an optional binder material 62. Zeolite-base metal particles 60 and binder 62 define a plurality of pores 58 situated throughout the walls 50. The binder material 62 is generally present in embodiments before the substrate 40 is sintered which incinerates a portion or all of the binder 62. Incineration of the binder 62 typically may increase the volume of pores in the substrate 40. In certain embodiments, before substrate 40 is sintered, a pore-forming material is also present. Typically, the pore-forming material is incinerated during sintering leaving pores 58.

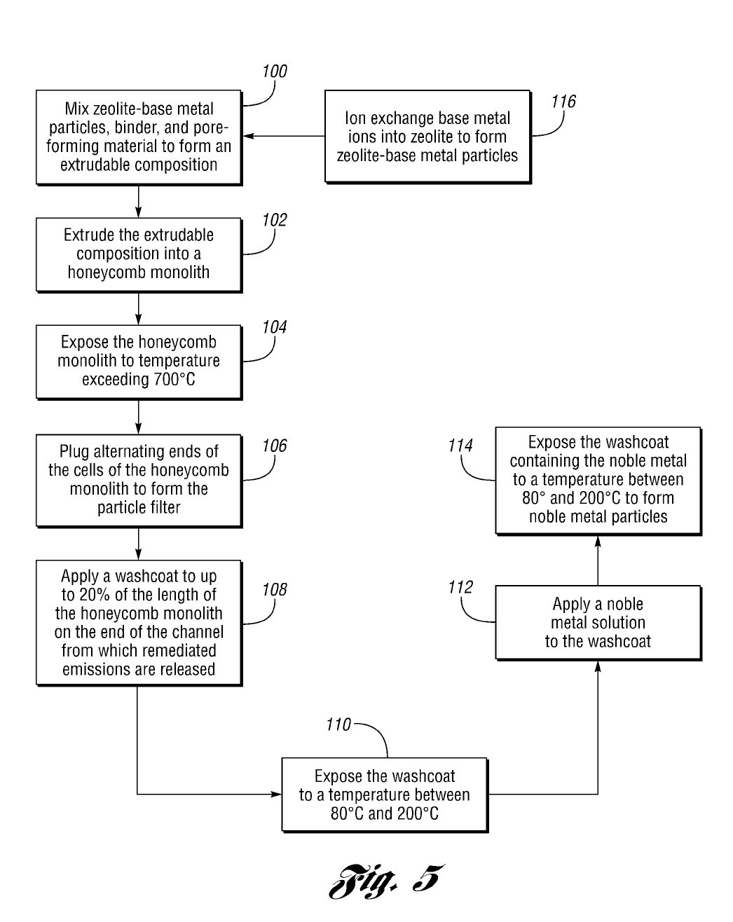

The wall 50 adjacent to outlet channel 52 in the substrate 40 is then coated in at least one embodiment with a washcoat 64 having noble metal particles 66, such as microcrystallites, as schematically illustrated in FIG. 4.

In at least one embodiment, the washcoat 64 is applied up to 50% of the total length of SCRF 20. In another embodiment, the length of SCRF that is coated with washcoat 64 is less than 20% of the total length of the SCRF. In yet another embodiment, washcoat 64 is applied up to 15% of the total length of the SCRF.

It is understood that noble metal particles 66 may be situated in a range of 10% of the total length of the SCRF to 100% of the total length of the SCRF in at least one embodiment. In another embodiment, the noble metal particles 66 may be situated substantially in a range of 20% of the total length of the SCRF to 50% of the total length of the SCRF.

In another embodiment, noble metal particles 66 may be situated substantially in a range of 10% of the length of washcoat 64 to 150% of the length of washcoat 64. In another embodiment, noble metal particles 66 may be situated substantially within a range of 50% of the length of washcoat 64 to 100% of the length of washcoat 64.

The amount of noble metal particles in the catalyst ranges from 0.1 wt. % to 3 wt. % in at least one embodiment. In another embodiment, the amount of noble metal particles ranges from 0.5 wt. % to 1.5 wt. %.

In another embodiment, the amount of noble metal particles 66 ranges from 0.5 g/ft³. to 5 g/ft³. In yet another embodiment, the amount of noble metal particles ranges from 1 g/ft³ to 4 g/ft³.

Noble metal particles 66 may include but are not limited to particles of platinum, palladium, rhodium, gold, rhenium, osmium, and iridium. Palladium and/or platinum are preferred for controlling slip of carbon monoxide, hydrocarbons, and ammonia, from SCRF 20.

The ratio of palladium to platinum content ranges from 0.1 to 10 in at least one embodiment. In another embodiment, the ratio of palladium content to platinum content ranges from 0.2 to 5.

Wall 50 typically has porosity effective to allow emission 16 to pass through wall 50 without causing significantly higher back pressure than selective catalytic reduction (SCR) systems known in the prior art. As a non-limiting example of the porosity measurement, wall 50, in at least one embodiment, induces the back pressure of less than 20 inches of water.

In at least one embodiment, wall 50 has a porosity ranging from 40 vol. % to 85 vol. %. In yet another embodiment the porosity of wall 40 ranges from 45 vol. % to 60 vol. %.

In at least one embodiment, the average pore size of wall 50 ranges from 10 micrometers in diameter to 30 micrometers in diameter. In yet another embodiment, the average pore size of wall 50 ranges from 15 micrometers in diameter to 25 micrometers in diameter. The average pore size, in at least one embodiment, includes the effective width of the channel in interconnecting interstices. In yet another embodiment, the pore size includes the average effective channel width of cavities in structural subunits of compositions of zeolite-base metal particles 60 used in making wall 50.

In at least one embodiment, wall 50 includes at least one composition of a zeolite or other compositions having structural subunits (SSU), such as an alumina phosphate. The zeolite contains distinct tetrahedral MO₄ structural subunits, where M may be silicon, aluminum, phosphorous, gallium, boron, or beryllium. The zeolite may include both finite and infinite component units. Non-limiting examples of finite units include finite structural subunits and secondary building units (SBU), such as 4-member, 5-member, or 6-member rings. Non-limiting examples of infinite component units are component chains and component layers. Non-limiting examples of zeolite component chains include zigzag chains, saw chains, crankshaft chains. Non-limiting examples of component layers include single 3-member rings and/or 4-member rings, double 4-member rings, 5-member rings, double 6-member rings, non-connected 6-member rings (ABC-6 Family), beta and/or beta-like families, clathrasils, and cages. In at least one embodiment, a chabazite zeolite is preferred, such as CHA, SSZ-62, SAPO-34, SAPO-44 zeolites.

A non-limiting example of forming zeolite suitable for use in wall 50 is disclosed in U.S. Pat. No. 6,709,644, which is incorporated herein by reference.

The silicon to aluminum ratio ranges from 10 to 20 in at least one embodiment. In another embodiment, the silicon to aluminum ratio ranges from 12 to 15.

In at least one embodiment, the Group I and/or Group II average metal content of the zeolite before ion-exchange conversion into zeolite-base metal particle 60, ranges from 0.01 wt. % of the zeolite to 5 wt. % of the zeolite on a metal oxide basis. In another embodiment, the Group I and/or Group II average metal content of the zeolite before ion-exchange conversion into zeolite-base metal particle 60, ranges from 0.1 wt. % to 2 wt. % of the zeolite.

In at least one embodiment, the zeolite after ion-exchange conversion includes less than 0.5 wt. % of Group I and/or Group II average metal content on a metal oxide basis, preferably being substantially in hydrogen ion-form when fresh.

Zeolite-base metal particles 60 may be comprised of at least one zeolite having base metals introduced to ion-exchangeable sites situated in and/or on the zeolite. Non-limiting methods of ion-exchanging base metal ions have been disclosed in the art, such as in U.S. Pat. No. 7,704,475.

In at least one embodiment, Group I and/or Group II metal ions present in the zeolite are removed by ion exchange methods known in the art. The Group I and/or Group II metal ions are replaced by either base metal ions or hydrogen ions. Optionally, in another embodiment, the hydrogen ions are replaced by the base metal ions in a second step. It should be understood that more than one type of base metal ion may be used during ion exchange with the zeolite without exceeding the scope and/or spirit of the embodiments herein.

Base metals suitable for inclusion in zeolite-base metal particles 60 include, but are not limited to, a base metal catalyst for use in oxidizing NO to NO₂, a transition metal, and a base metal capable of alternating between at least two oxidation states. Preferably, base metal for inclusion in zeolite-base metal particles 60 include manganese, molybdenum, titanium, vanadium, tungsten, copper, cobalt, iron and/or nickel.

In at least one embodiment, the average base metal content of the zeolite-base metal particles ranges from 1 wt. % to 15 wt. % of the zeolite-base metal particle. In another embodiment, the average base metal content of the zeolite-base metal particle ranges from 2 wt. % to 5 wt. % of the zeolite-base metal particle.

In at least one embodiment, the binder comprises an inorganic polymer. In another embodiment, the binder comprises alumina, silica, and/or zirconia. In yet another embodiment, the binder comprises silicone resins and silicone emulsions. Non-limiting examples of the binder are disclosed in U.S. Pat. No. 7,754,638.

The ratio of zeolite-base metal particles binder to a sintered monolith ranges from 1 to 9.

The pore-forming material comprises an organic polymer in at least one embodiment. In another embodiment, the pore-forming material comprises lignocellulosic and/or graphitic polymers. In yet another embodiment, the pore-forming material comprises starches and/or graphite.

The composition of the extrudate includes the following shown in Table 1, which may be independently selected:

| | Embodiment | Embodiment | Embodiment |
|---|---|---|---|
| Component | 1 | 2 | 3 |
| Zeolite-base | 7.5-54 wt. % | 12.5-45 wt. % | 15-35 wt. % |
| metal | | | |
| particles | | | |
| Binder | 6-7.5 wt. % | 5-12.5 wt. % | 3.9-15 wt. % |
| Pore-forming | 40-85 wt. % | 50-75 wt. % | 55-70 wt. % |
| Composition | | | |

After sintering the extrudate, the porosity of the monolith ranges from 40 vol. % to 85 vol. %, in at least one embodiment. In another embodiment, the porosity of the monolith ranges from 50 vol. % to 75 vol. %. In yet another embodiment, the porosity of the monolith ranges from 55 vol. % to 70 vol. %.

Base metals in zeolite-base metal particles 60 preferably include base metal moieties capable of having oxygen storage capacity, capable of undergoing redox reaction, and/or oxidizing NH₃. It should be understood that other metal moieties which promote the activity of the zeolite base metal particles 60 may be included in certain embodiments of the composition of wall 50. It is further understood that one or more base metals may be included in the composition of wall 50 without exceeding the scope and spirit of the embodiments.

Regarding FIG. 5, a method for manufacturing the device for remediating emissions includes mixing the zeolite-base metal particles 60, binder 62, and pore-forming material to form an extrudable composition in step 100.

The zeolite-base metal particles 60 may be formed by ion-exchanging the base metal ions directly for the Group I and/or Group II metal ions initially on the zeolite in step 116. In an alternative embodiment, the Group I and/or Group II metal ions are ion-exchanged out of the zeolite by hydrogen ions from acid. The hydrogen ions are ion-exchanged out by the base metal ions.

In step 102, the extrudable composition is extruded into a honeycomb monolith, such as a 10 cell per square inch honeycomb monolith. In step 104, the honeycomb monolith is exposed to a temperature exceeding 700° C. to form the sintered ceramic composition.

In step 106, alternating ends of the cells of the honeycomb monolith are plugged to form the particle filter.

In step 108, a washcoat is applied to up to 20% of the length of the honeycomb monolith. The washcoat is applied to the end of the channel from which the remediated emissions are released. A non-limiting example of the washcoat includes gamma-aluminum oxide dissolved in nitric acid having a pH ranging from 0.5 to 3. The dissolved alumina forms a slurry which can then be applied as a washcoat using processes known in the art such as dipping and vacuum deposition. In at least one embodiment, the washcoat 64 is substantially contiguous with the open end of the outlet channel.

In step 110, the washcoated monolith is exposed to a temperature between 80° C. and 200° C. to calcine the washcoat 64.

In step 112, a noble metal solution is applied to the washcoat. In step 114, the washcoat 64 containing the noble metal solution is exposed to a temperature between 80° C. and 200° C. to form the noble metal particles 66.

While the best mode for carrying out the invention has been described in detail, those familiar with the art to which this invention relates will recognize various alternative designs and embodiments for practicing the invention as defined by the following claims.

What is claimed:

1. A combined selective catalytic reduction catalyst and particulate filter (SCRF), comprising:
a particulate filter having walls defining an intake channel including a downstream end cap and an outlet channel including an upstream end cap and an open end, the walls defining a plurality of pores, and including a plurality of zeolite-base metal particles;
a washcoat adjacent to the wall, wherein the washcoat is capable of receiving noble metal particles and is adjacent to less than 50% of the length of the outlet channel.

2. The SCRF of claim 1, wherein the zeolite-base metal particles are capable of oxidizing NO to NO₂.

3. The SCRF of claim 1, wherein the washcoat includes noble metal particles.

4. The SCRF of claim 3, wherein the noble metal particles comprise 0.5 g/ft³ of the SCRF to 5 g/ft³ of the SCRF.

5. The SCRF of claim 3, the noble metal particles being proximate to the open end of the outlet channel.

6. The SCRF of claim 1, wherein the zeolite-base metal particles form 50 wt. % to 90 wt. % of the wall.

7. The SCRF of claim 4, wherein the base metal in the wall ranges from 1 wt. % to 15 wt. % of the zeolite-base metal particle.

8. The SCRF of claim 1, wherein the walls have an average pore size ranging from 10 micrometers in diameter to 30 micrometers in diameter.

9. The SCRF of claim 1, wherein the walls have a porosity ranging from 40 vol. % to 85 vol. %.

10. The SCRF of claim 1, wherein the zeolite-base metal particles include base metal disposed on an ion-exchangeable site of a zeolite structural subunit.

11. The SCRF of claim 1, wherein the washcoat is adjacent to less than 20% of the length of the outlet channel and is adjacent to the open end.

12. A combined selective catalytic reduction catalyst and particulate filter (SCRF), comprising:
a particulate filter having walls comprising a structural subunit (SSU) and NH₃-oxidizing composition particle, the filter defining an intake channel including a downstream end cap and an outlet channel including an upstream end cap and an open end, wherein the walls have a porosity ranging from 40 vol. % to 85 vol. %; and
a washcoat adjacent to the wall in the outlet channel, wherein the washcoat includes noble metal particles and is adjacent to less than 50% of the length of the outlet channel.

13. The SCRF of claim 12, wherein the SSU and NH₃-oxidizing composition particle includes a composition having an oxygen storage component.

14. The SCRF of claim 12, wherein the SSU and NH₃-oxidizing composition particle includes a composition having a base metal.

15. The SCRF of claim 12, wherein the SSU and NH₃-oxidizing composition particle is substantially in hydrogen-ion form when fresh after ion-exchange.

16. The SCRF of claim 12, wherein the washcoat is substantially contiguous and situated adjacent to the open end.

17. The SCRF of claim 12, wherein the noble metal particles are situated substantially adjacent to the open end.

18. The SCRF of claim 12, wherein the particle includes 1 wt. % to 15 wt. % base metal, when expressed as a metal.

19. A method of manufacture of a combined selective catalytic reduction catalyst and particulate filter (SCRF), comprising:
ion-exchanging a base metal ion into a zeolite to form a zeolite-base metal particle;
mixing the zeolite-base metal particle, a binder, and a pore-forming composition to form an extrudable mixture;
extruding the extrudable mixture to form a particulate filter having walls defining an intake channel including a downstream end cap and an outlet channel including an upstream end cap and an open end; and
incinerating the pore-forming material to form a particulate filter having 40 vol. % to 85 vol. % pores.

20. The method of claim 19, further comprises the steps of:
coating a layer adjacent to less than 50% of the length of the outlet channel;
heating the coated particulate filter;
applying noble metal to the layer; and
heating the noble metal to form the SCRF.
